(19) United States
(12) Patent Application Publication
(10) Pub. No.: US 2014/0139820 A1
(43) Pub. Date: May 22, 2014

(54) Methods for Measuring Fluid Flow in Subterranean Wells

(71) Applicant: SCHLUMBERGER TECHNOLOGY CORPORATION, Sugar Land, TX (US)

(72) Inventors: Pierre Vigneaux, Moisenay (FR); Eve Le Bastard, Le Plessis Robinson (FR); Thomas Barrou, Cachan (FR)

(73) Assignee: SCHLUMBERGER TECHNOLOGY CORPORATION, Sugar Land, TX (US)

(21) Appl. No.: 13/684,040

(22) Filed: Nov. 21, 2012

(51) Int. Cl. G01P 5/26

(52) U.S. Cl. CPC G01P 5/26
USPC 356/28

(57) ABSTRACT

A flow sensing apparatus includes a light source, at least one fiber Bragg grating and at least one optical fiber. The apparatus may be inserted into a flowing fluid stream, and the fiber Bragg grating detects the vortices of the Von Karman street in the wake of the apparatus. The fiber Bragg grating reflects light emitted from the light source, and the spectral nature of the reflected light provides information concerning the fluid velocity in the flowing stream.

### BACKGROUND

The statements in this section merely provide background information related to the present disclosure and may not constitute prior art.

This disclosure relates to methods for measuring the flow rate of fluids circulating inside of and emanating from subterranean wells.

Virtually all phases of well construction, stimulation and production involve the movement of fluids into or out of the well. Accordingly, it is necessary for operators to have the ability to measure the rates at which fluids move into or out of a subterranean well.

### SUMMARY

The present disclosure provides improved flowmeters for use in oil wells. The devices use a fiber Bragg grating to detect Von Karman vortices in fluids flowing into or out of a subterranean well. In particular, the devices are suitable for measuring annular return flow.

In an aspect, embodiments relate to a flow-measurement apparatus. The apparatus comprises a flow sensing apparatus comprising a bluff body and at least one optical fiber comprising a fiber Bragg grating. In addition the flow-measurement apparatus comprises a light source and a receiver.

In a further aspect, embodiments relate to methods for measuring the flow rate of a fluid. A flow sensing apparatus is inserted into a flowing fluid stream. The apparatus comprises a bluff body and at least one optical fiber comprising a fiber Bragg grating. The fiber Bragg grating is used to detect vortices of a Von Karman street. Light is emitted from a light source, and the light is transmitted to the grating through the optical fiber. The grating collects the transmitted light and reflects the light through the optical fiber to a receiver. The fiber Bragg grating wavelength data are collected over time, whereupon a frequency analysis is performed from which a flow rate may be determined.

In yet a further aspect, embodiments relate to methods for measuring the flow rate of a fluid in a subterranean well having a borehole. A flow-sensing apparatus is inserted into a flowing fluid stream in the borehole. The apparatus comprises a bluff body and at least one optical fiber comprising a fiber Bragg grating. The fiber Bragg grating is used to detect vortices of a Von Karman street. Light is emitted from a light source, and the light is transmitted to the grating through the optical fiber. The grating collects the transmitted light and reflects the light through the optical fiber to a receiver. The fiber Bragg grating wavelength data are collected over time, whereupon a frequency analysis is performed from which a flow rate may be determined.

In yet a further aspect, embodiments relate to methods for using a fiber Bragg grating to measure the flow rate of a fluid in a subterranean well having a borehole. The fiber Bragg grating is incorporated into a flow sensing apparatus, wherein the flow sensing apparatus further comprises a bluff body and at least one optical fiber. The fiber Bragg grating is used to detect vortices of a Von Karman street. Light is emitted from a light source, and the light is transmitted to the grating through the optical fiber. The grating collects the transmitted light and reflects the light through the optical fiber to a receiver. The fiber Bragg grating wavelength data are collected over time, whereupon a frequency analysis is performed from which a flow rate may be determined.

### BRIEF DESCRIPTION OF THE DRAWINGS

FIG. 1 shows how the disclosed flowmeter may be inserted in a subterranean well.

FIGS. 2A and 2B are schematic views of an embodiment of the vortex insertion flowmeter.

FIG. 3 is a schematic diagram of an embodiment of the flowmeter.

FIG. 4 is plot showing the optical flowmeter vortex frequency versus flow velocity, from the Example.

### DETAILED DESCRIPTION

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

Direct measurement of the flow rate of fluids entering or exiting the annulus of a subterranean well is not a common practice. Persons skilled in the art will recognize that applying previous measurement techniques known in the art to annular-flow measurements would require complex and costly rig modifications, as well as materials that satisfy the ATEX Zone 0 directive. Such materials must be compatible with an atmosphere where a mixture of air and flammable substances in the form of gas, vapor or mist is present frequently, continuously or for long periods. However, such measurements would allow direct measurement of fluid-loss or spurt-loss, as well as improved kick or blowout detection.

A flow sensing apparatus proposed herein, a vortex insertion optical flowmeter, may not require rig modifications. The measurements may be performed with any fluid present in the well or formation layers, in virtually all sizes of annuli or tubulars.

The flowmeter is based on the use of a fiber Bragg grating (FBG) as a strain sensor in von Karman street vortices created by an obstacle, also known as a “bluff body” in the flow path. When a fluid flows steadily past the bluff body, swirling vortices are created on the downstream side. For example, the trail behind a cylinder comprises two alternating vortices: one up and one down. This commonly known as the von Karman street.

Vortex flowmeters measure the vibrations induced by the alternance of downstream vortices. The vibrating frequency may be related to the flow velocity, as described by the following equation.

$${f}_{v} = \frac{Sr \times V}{D} \qquad ( Eq . 1 )$$

where fᵥ is the frequency of the vortices; Sr is the Strouhal number, V is the mean flow velocity and D is the characteristic length of the bluff body. Knowing the oscillation frequency is thus sufficient to determine the average fluid velocity. The Strouhal number is related to the dimensionless Reynold's number, defined as follows.

$$Re = \frac{ρ V L}{μ} , \qquad ( Eq . 2 )$$

where ρ is the fluid density; L is the characteristic length of the bluff body; and μis the dynamic viscosity of the fluid. For spheres in a uniform flow and for a Reynolds number range between 250 and 200,000, two values of the Strouhal number coexist. The lower frequency is the one of interest, and is approximately equal to 0.2.

The size of the bluff body should be smaller than the pipe or annulus in which it is inserted, and may be as small as the diameter of the optical fiber. Indeed, the bluff body may be part of the optical fiber itself.

The vortex insertion optical flowmeter is based on the measurement of vibrations exerted on a FBG in a flowing fluid. Placed in the wake of an obstacle, the FBG will vibrate in the Von Karman street and the reflected wavelength will vary with the frequency of the vortices. A Fourier transform of the wavelength signal allows one to determine the frequency and thus the fluid velocity

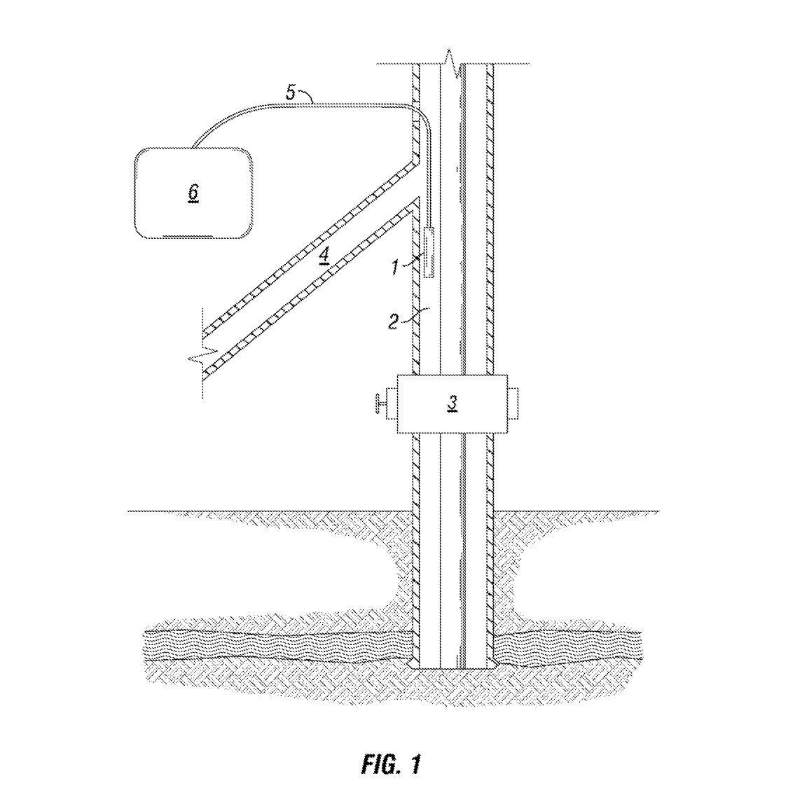

An apparatus containing the bluff body, the FBG and an optical fiber is the vortex insertion optical flowmeter (FIG. 1). The vortex insertion flowmeter 1 may be placed in the annulus 2 above the blowout preventer (BOP) 3 and below the return line 4. However, those skilled in the art will recognize that the placement of the flowmeter would not be limited to this particular location. The annular section where the flowmeter is positioned is known precisely; therefore, the measurement can be directly expressed as flow rate. An optical fiber 5 transmits the light from the flowmeter to the receiver 6.

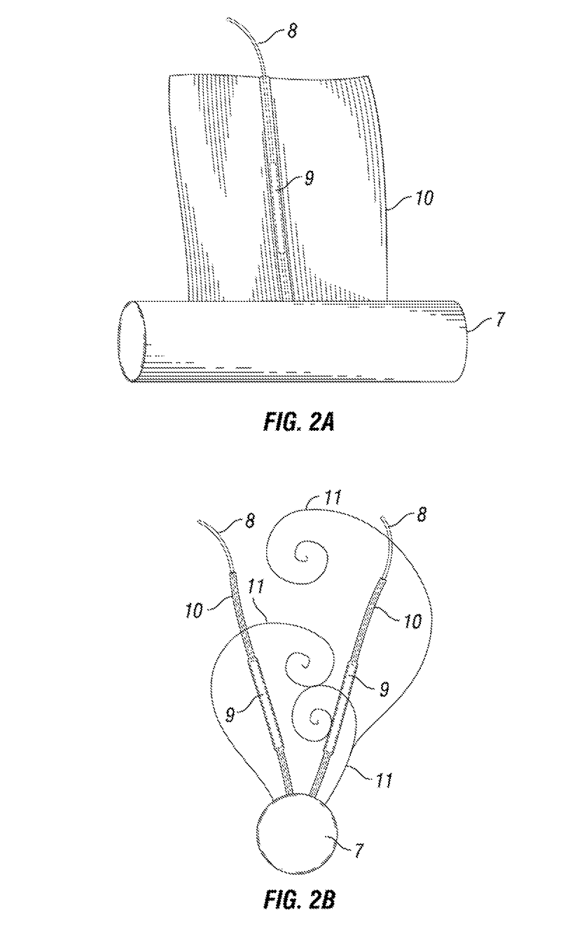

Detailed drawings of an embodiment of the vortex insertion flowmeter 1 are presented in FIGS. 2A and 2B. The bluff body 7 is connected to at least one optical fiber 8 that incorporates a fiber Bragg grating 9. A sail 10 helps keep the flowmeter aligned in the direction of fluid flow so that the fiber Bragg grating may properly analyze the vortices 11 created in the wake of the bluff body 7.

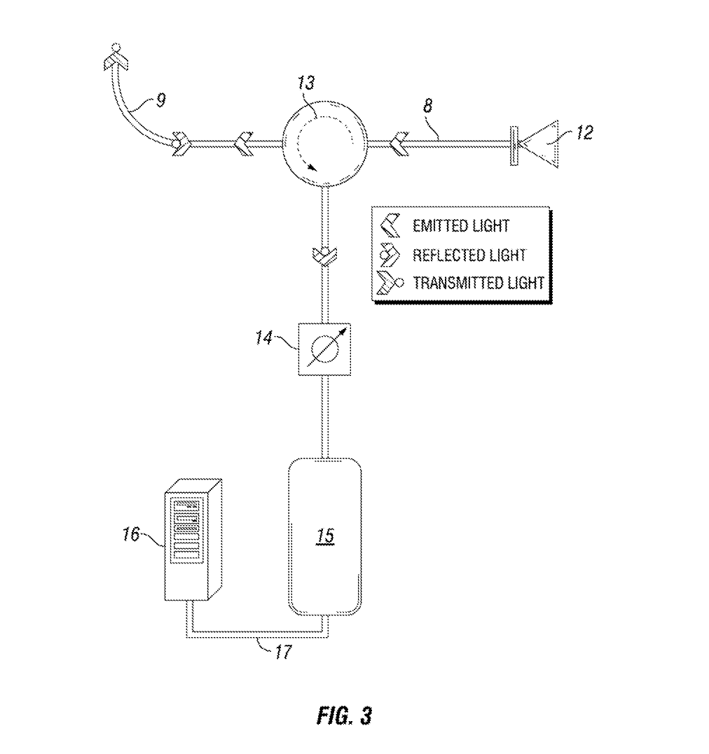

A schematic diagram of one embodiment is shown in FIG. 3. The system includes (but would not be limited to) a super-luminescent light emitting diode (SLED) 12, an optical circulator 13, an optical attenuator 14, a high-speed interrogation monitor or receiver that may comprise a spectrometer 15 and a computer 16. The SLED provides broadband light. The emitted light is guided to the optical circulator via the optical fiber 8. The light is directed to the FBG 9 which, depending on how it has been perturbed by the fluid flow, reflects the light at a certain wavelength back to the optical circulator. The reflected light is then directed to the spectrometer the in turn transmits the wavelength data to the computer via a bus connection 17 such as USB.

In an aspect, embodiments relate to a flow-measurement apparatus. The apparatus comprises a flow-sensing apparatus that comprises at least one optical fiber comprising a fiber Bragg grating. In addition, the flow-measurement apparatus comprises a light source and a receiver.

In a further aspect, embodiments relate to methods for measuring the flow rate of a fluid. A flow sensing apparatus is inserted into a flowing fluid stream. The apparatus comprises a bluff body and at least one optical fiber comprising a fiber Bragg grating. The fiber Bragg grating is used to detect vortices of a Von Karman street. Light is emitted from a light source, and the light is transmitted to the grating through the optical fiber. The grating collects the transmitted light and reflects the light through the optical fiber to a receiver. The fiber Bragg grating wavelength data are collected over time, whereupon a frequency analysis is performed from which a flow rate may be determined.

In yet a further aspect, embodiments relate to methods for measuring the flow rate of a fluid in a subterranean well having a borehole. A flow-sensing apparatus is inserted into a flowing fluid stream in the borehole. The flow-sensing apparatus may be placed in a casing/borehole annulus above a blowout preventer and below a return line. The apparatus comprises a bluff body and at least one optical fiber comprising a fiber Bragg grating. The fiber Bragg grating is used to detect vortices of a Von Karman street. Light is emitted from a light source, and the light is transmitted to the grating through the optical fiber. The grating collects the transmitted light and reflects the light through the optical fiber to a receiver. The fiber Bragg grating wavelength data are collected over time, whereupon a frequency analysis is performed from which a flow rate may be determined.

In yet a further aspect, embodiments relate to methods for using a fiber Bragg grating to measure the flow rate of a fluid in a subterranean well having a borehole. The fiber Bragg grating is incorporated into a flow sensing apparatus, wherein the flow sensing apparatus further comprises a bluff body and at least one optical fiber. The fiber Bragg grating is used to detect vortices of a Von Karman street. Light is emitted from a light source, and the light is transmitted to the grating through the optical fiber. The grating collects the transmitted light and reflects the light through the optical fiber to a receiver. The fiber Bragg grating wavelength data are collected over time, whereupon a frequency analysis is performed from which a flow rate may be determined.

For all aspects, the light source may be a broadband light source such as (but not limited to) a superluminescent light emitting diode (SLED) and the receiver may be a spectrometer. The light source may be a tunable laser and the receiver may be a photodetector.

For all aspects, the flowmeter may further comprise an optical circulator, wherein the light emitted from the light source is transmitted through the optical circulator to the grating, and the reflected light from the grating travels back through the optical circulator and is redirected to the receiver.

For all aspects, the flowmeter may further comprise an optical circulator, wherein the light emitted from the light source is transmitted through the optical circulator back and forth to the grating through an optical fiber. The computer and receiver may be in a location that is remote from the flow sensing apparatus. The flowmeter may further comprise an optical attenuator to adjust the light intensity that is transmitted to the interrogation monitor.

For all aspects, the flow-sensing apparatus may further comprise at least a sail.

For all aspects, the computer and receiver may be in a location that is remote from the flow sensing apparatus—for example at the surface. Additionally, the flow sensing apparatus may further comprise an optical attenuator.

### EXAMPLE

The disclosed methods may be further illustrated by the following example.

A laboratory-scale flow sensing apparatus was constructed. A length of 0.1-m diameter hollow PVC pipe represented the well. An eight-speed fan circulated air through the pipe. A bluff body (a 0.05-m diameter plastic cylinder) was placed in the air flow, thereby creating a Von Karman street. A FBG connected to an optical fiber was placed in the vortices behind the bluff body, perpendicular to the length of the pipe. A super-luminescent light emitting diode (SLED) was used as a broadband light source, centered on a wavelength of 1310 nm. The emitted light was guided to an optical circulator via optical fiber. The light was directed to the FBG, which reflected light at a wavelength of 1300 nm. The vortices created by the bluff body modified the strain applied to the FBG, and thus the wavelength at which the light was backscattered. The reflected light traveled back to the optical circulator and was directed to a spectrometer capable of performing measurements at a high frequency. The spectrometer data were sent to a computer for real-time analysis. The computer performed a fast Fourier transform (FFT) on the data, providing frequency measurements on the vortices and calculating the velocities of air traveling through the pipe. With this experimental setup, using Eq. 1, the frequency was calculated as follows.

$$f \approx \frac{0.2 V ( m \text{/} s )}{0.5 ( m )} \approx 4 V .$$

To confirm the calculated air velocity measurements, an external anemometer was mounted at the outlet of the pipe. The measurement precision was ±0.1 m/s. Table 1 shows the fan speeds and their associated velocities.

TABLE 1
Air velocities corresponding to fan speeds.

| Speed Number | Corresponding Air Velocity (m/s) |
|---|---|
| 1 | 2.7 |
| 2 | 2.8 |
| 3 | 3.4 |
| 4 | 3.8 |
| 5 | 4.8 |
| 6 | 5.1 |
| 7 | 5.3 |
| 8 | 5.6 |

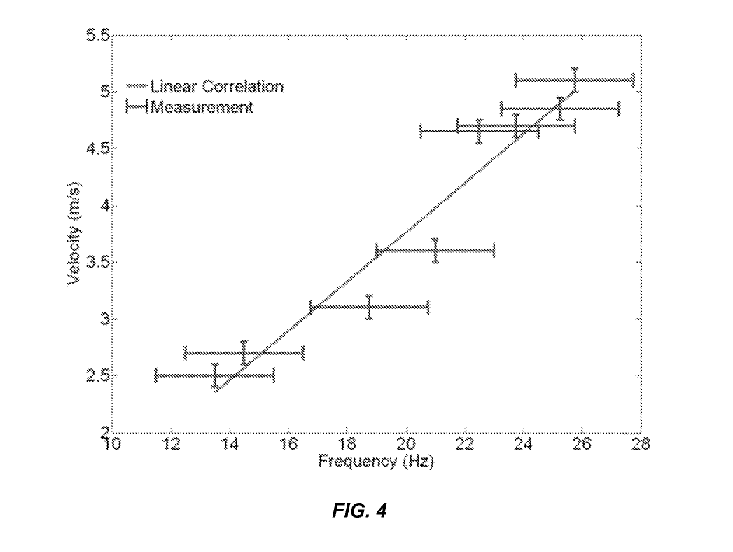

The test apparatus was operated at the eight air velocities, and the frequencies at which the fiber Bragg grating reflected the light were measured. The results, shown in FIG. 4, showed that the measured frequencies increased with fluid velocity, and the calculated fluid velocities corresponded well with those measured by the anemometer.

1. A flow-measurement apparatus, comprising:
(i) a flow sensing apparatus comprising a bluff body and at least one optical fiber comprising a fiber Bragg grating;
(ii) a light source; and
(iii) a receiver.

2. The apparatus of claim 1, further comprising an optical circulator.

3. The apparatus of claim 1, further comprising an optical attenuator.

4. The apparatus of claim 1, further comprising at least a sail.

5. The apparatus of claim 1, wherein the light source is a broadband light source.

6. The apparatus of claim 1, wherein the light source is a tunable laser.

7. The apparatus of claim 1, wherein the receiver is a high speed interrogation monitor.

8. The apparatus of claim 7, wherein the high speed interrogation monitor is a spectrometer.

9. The apparatus of claim 1, wherein the receiver is a photodetector.

10. A method for measuring the flow rate of a fluid, comprising:
(i) inserting a flow sensing apparatus into a flowing fluid stream, the apparatus comprising a bluff body and at least one optical fiber comprising a fiber Bragg grating;
(ii) using the fiber Bragg grating to detect vortices of a Von Karman street;
(iii) emitting light from a light source, and transmitting the light to the grating through the optical fiber;
(iv) allowing the grating to collect the transmitted light and reflect the light through the optical fiber to a receiver;
(v) collecting fiber Bragg grating wavelength data over time;
(vi) performing a frequency analysis of the wavelength data using a Fourier transform; and
(vii) thereby determining the flow rate.

11. The method of claim 10, wherein the light source is a broadband light source, and the receiver is a spectrometer.

12. The method of claim 10, wherein the light source is a tunable laser, and the receiver is a photodetector.

13. The method of claim 10, wherein the flow sensing apparatus further comprises an optical circulator, wherein the light emitted from the light source is transmitted through the optical circulator, and the reflected light from the grating travels back through the optical circulator and is redirected to the receiver.

14. The method of claim 10, wherein the flow sensing apparatus further comprises an optical attenuator.

15. A method for measuring the flow rate of a fluid in a subterranean well having a borehole, comprising:
(i) inserting a flow sensing apparatus into a flowing fluid stream in the borehole, the apparatus comprising a light source, at least one fiber Bragg grating and at least one optical fiber;
(ii) using the fiber Bragg grating to detect vortices of a Von Karman street;
(iii) emitting light from a light source, and transmitting the light to the grating through the optical fiber;
(iv) allowing the grating to collect the transmitted light and reflect the light through the optical fiber to a receiver;
(v) collecting fiber Bragg grating wavelength data over time;
(vi) performing a frequency analysis of the wavelength data using a Fourier transform; and
(vii) thereby determining the flow rate.

16. The method of claim 15, wherein the light source is a broadband light source, and the receiver is a spectrometer.

17. The method of claim 15, wherein the light source is a tunable laser, and the receiver is a photodetector.

18. The method of claim 15, wherein the flow sensing apparatus further comprises an optical circulator, wherein the light emitted from the light source is transmitted through the optical circulator, and the reflected light from the grating travels back through the optical circulator and is redirected to the receiver.

19. The method of claim 15, wherein the flow sensing apparatus further comprises an optical attenuator.

20. The method of claim 15, wherein the flow sensing apparatus is placed in a casing/borehole annulus above a blowout preventer and below a return line.
